(19) United States
(12) Patent Application Publication
(10) Pub. No.: US 2010/0274865 A1
(43) Pub. Date: Oct. 28, 2010

(54) TRAVEL TIME DEPENDENT NOTIFICATION SYSTEM

(75) Inventors: Kristopher T. Frazier, Frisco, TX (US); Jayson Sellers, Carrollton, TX (US); Sok Young Hwang, Dallas, TX (US); Summer Westbrook, Plano, TX (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/428,676

(22) Filed: Apr. 23, 2009

(51) Int. Cl. G06F 15/16; G06F 17/30; G01C 21/00

(52) U.S. Cl. 709/207; 707/E17.044; 707/E17.018; 701/201

(57) ABSTRACT

A computer-readable medium may include computer-executable instructions. The computer-executable instructions may include instructions for identifying an event that is scheduled to be attended by a user, determining a current location of a device associated with the user, determining an estimated amount of time that the user needs to travel from the current location to the event, and sending an alert to notify the user, the alert indicating the amount of time that is available to the user to travel to the event.

### BACKGROUND INFORMATION

A typical calendar application (e.g., Google calendar, Microsoft calendar, etc.) on a computer or a hand-held device (e.g., a mobile phone) allows a user to schedule an event (e.g., a meeting). The user can configure the calendar application so that the application will notify the user (e.g., opens a window with a text message) at a predetermined amount of time prior to the actual event.

### BRIEF DESCRIPTION OF THE DRAWINGS

FIG. 1 is a block diagram illustrating an exemplary system in which concepts described herein may be implemented;

FIG. 2A is a diagram of a device shown in FIG. 1 according to one exemplary embodiment;

FIG. 2B is a diagram of a device shown in FIG. 1 according to another exemplary embodiment;

FIG. 3 is a block diagram illustrating exemplary components of a device shown in FIG. 1;

FIG. 4 is a block diagram illustrating exemplary functional components of a device shown in FIG. 1;

FIG. 5 is a block diagram illustrating exemplary functional components of a server device shown in FIG. 1;

FIG. 6 is a diagram illustrating a view of graphical user interface (GUI) of a notification module installed on the device shown in FIG. 2B;

FIG. 7 is a flow diagram of an exemplary process that is associated with operation of the system shown in FIG. 1; and

FIG. 8 illustrates an example associated with the operation of the system shown in FIG. 1.

### DETAILED DESCRIPTION OF PREFERRED EMBODIMENTS

The following detailed description refers to the accompanying drawings. The same reference numbers in different drawings may identify the same or similar elements.

As described below, a device (e.g., a mobile or cellular telephone, a laptop computer, a notebook computer, a personal computer, etc.) may provide a travel time dependent notification. Based on a user's current location and other factors (e.g., possible travel routes and traffic conditions), the device may determine the amount of time the user may need to travel to another location (e.g., the location of the next event). Depending on the amount of time that the user may need, the device may notify the user, send messages to other parties (e.g., other attendees of the event), re-schedule, and/or cancel the next event. By accounting for the user's potential travel time, the device may provide more useful information to the user and/or other parties than other types of systems/devices that provide notifications.

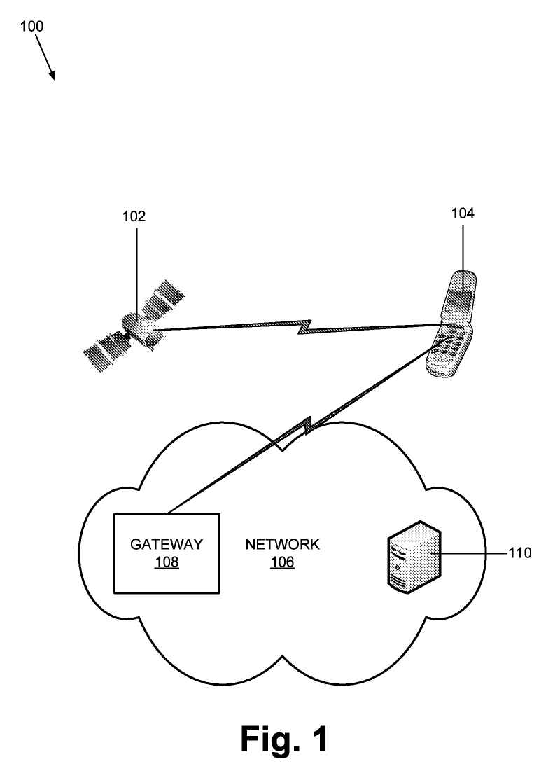

FIG. 1 shows an exemplary system 100 in which concepts described herein may be implemented. As shown, system 100 may include location devices (e.g., satellites) 102, a device 104, and a network 106. Depending on the embodiment, system 100 may include fewer, additional, or different devices than those illustrated in FIG. 1. For example, in one embodiment, system 100 may include additional location devices 102 and/or devices 104.

Location devices 102 may provide signals from which a device (e.g., device 104) may determine the device's locations. Examples of location devices 102 may include cellular transmission towers, global positioning system (GPS) satellites, etc.

Device 104 may include any of the following devices that have the ability to or are adapted to communicate with another device and/or host an application: a mobile telephone, a personal digital assistant (PDA), an electronic notepad, a laptop computer, a digital television, a gaming console, a personal computer (PC), a media playing device, a wireless/Bluetooth-enabled display; etc. Device 104 may obtain its own location based on signals from location devices 102, components (e.g., software and hardware components) within device 104, and/or other devices in network 106. In addition, device 104 may provide travel time dependent notifications.

Network 106 may include one or more wired and/or wireless networks that are capable of exchanging information, such as voice, video, documents, multimedia, text, etc. For example, network 106 may include one or more public switched telephone networks (PSTNs) or another type of switched network. Network 106 may also include one or more wireless networks and may include a number of transmission towers for receiving wireless signals and relaying the received signals toward the intended destination. Network 106 may further include one or more packet switched networks, such as an IP based network, a local area network (LAN), a wide area network (WAN), a personal area network (PAN), an intranet, the Internet, or another type of network that is capable of exchanging information.

As further shown in FIG. 1, network 106 may include a gateway 108 and server device 110. For simplicity and ease of understanding, network 106 of FIG. 1 does not show other network components, such as routers, switches, bridges, etc. or interconnections. In addition, network 106 may include fewer, additional, or different devices than those illustrated in FIG. 1. For example, in one embodiment, network 106 may include additional gateways and/or server devices.

Gateway 108 may relay signals to/from devices in network 106 from/to other devices (e.g., device 104) via wired, wireless, optical communication links. Server device 110 may exchange information with device 104, such that device 104 can provide travel time dependent notifications to users and/or other services. Server device 110 may communicate with device 104 via gateway 108 (e.g., a wireless access point (WAP)) or via other mechanisms.

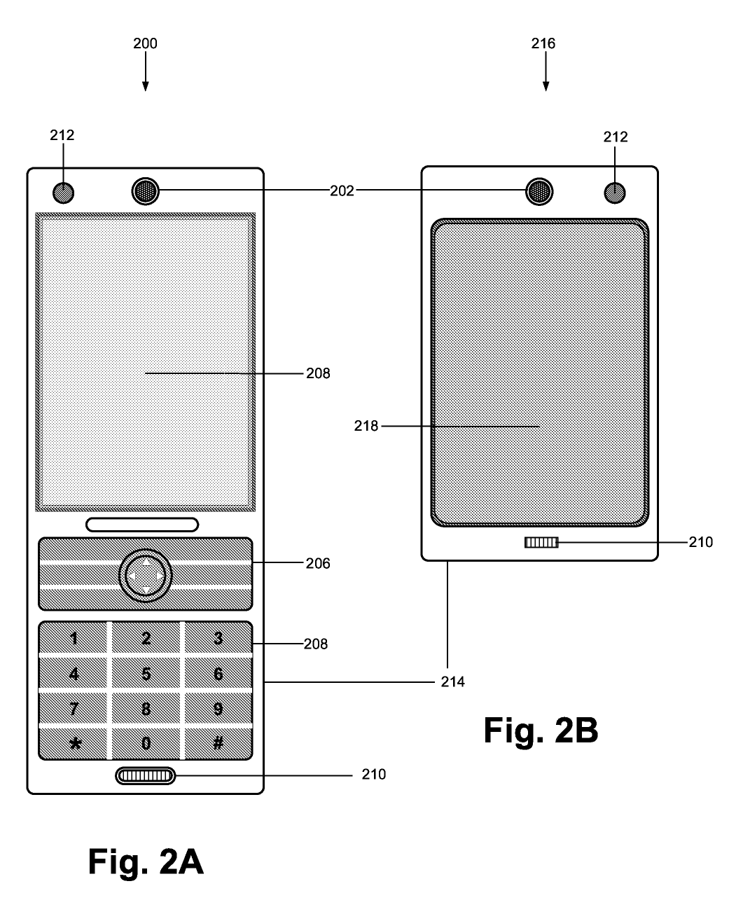

FIG. 2A is a diagram of device 104 according one exemplary embodiment 200. In this embodiment, device 104 is in the form of a portable phone (e.g., a cell phone). As shown in FIG. 2A, device 200 includes a speaker 202, display 204, control buttons 206, keypad 208, microphone 210, sensor 212, and housing 214.

Speaker 202 may provide audible information to a user of device 200. Display 204 may provide visual information to the user, such as an image of a caller, video images, text, pictures, etc. Control buttons 206 permit the user to interact with device 200 to cause device 200 to perform one or more operations, such as place or receive a telephone call. Keypad 208 may include a standard telephone keypad.

Microphone 210 may receive audible information from the user. Sensors 212 may collect and provide, to device 200, information (e.g., ambient light intensity, acoustic information, infrared information, etc.) that may be used to aid the user in capturing images. Housing 214 provides a casing for components of 200 and may protect the components from outside elements. Although not illustrated in FIG. 2A, device 200 may include additional, fewer, or different components, such as a flash, a camera lens assembly (e.g., a set of zoom lens), etc.

FIG. 2B is a diagram of device 104 according to another exemplary embodiment 216. In FIG. 2B, components that correspond to those in FIG. 2A are labeled with the same numbers. In contrast to device 200, device 216 may provide display 218 that includes a touch screen and a graphical user interface that replaces some of input/output components in device 200, such as control buttons 206 or keypad 208.

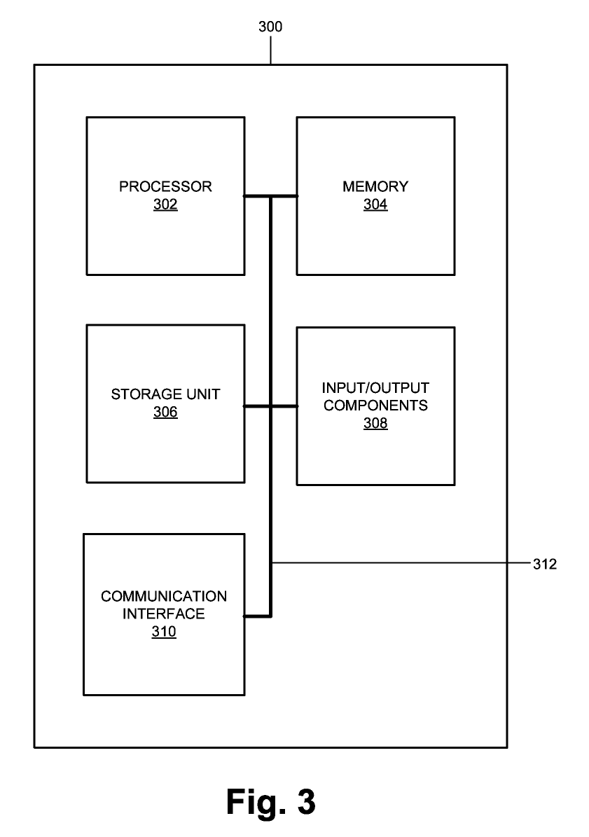

FIG. 3 is a block diagram illustrating exemplary components of a device 300. Device 300 may represent device 104 or server device 110. As shown in FIG. 3, device 300 may include a processor 302, memory 304, storage unit 306, input/output components 308, communication interface 310, and bus 312. Processor 302 may include one or more processors, microprocessors, application specific integrated circuits (ASICs), field programmable gate arrays (FPGAs), or other processing logic that may interpret and execute instructions. Memory 304 may include static memory, such as read only memory (ROM), and/or dynamic memory, such as random access memory (RAM) or onboard cache, for storing data and machine-readable instructions. Storage unit 306 may include a magnetic and/or optical storage/recording medium. In some embodiments, storage unit 306 may be mounted under a directory tree or may be mapped to a drive.

Input/output components 308 may include a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to device 300.

Communication interface 310 may include any transceiver-like mechanism that enables device 300 to communicate with other devices and/or systems. For example, communication interface 310 may include mechanisms for communicating via a network. In these embodiments, communication interface 310 may include one or more radio frequency (RF) transmitters, receivers and/or transceivers and one or more antennas for transmitting and receiving RF data. For example, communication interface 310 may include a radio or television tuner, a mobile telephone transceiver, etc. Communication interface 310 may also include a modem or an Ethernet interface to a LAN or other network for communicating with other devices. Bus 312 may provide an interface through which components of device 300 can communicate with one another.

In FIG. 3, device 300 is illustrated as including components 302-312 for simplicity and ease of understanding. In an actual implementation, device 300 may include additional, fewer, or different components. For example, device 300 may include one or more power supplies, fans, motherboards, video cards, etc.

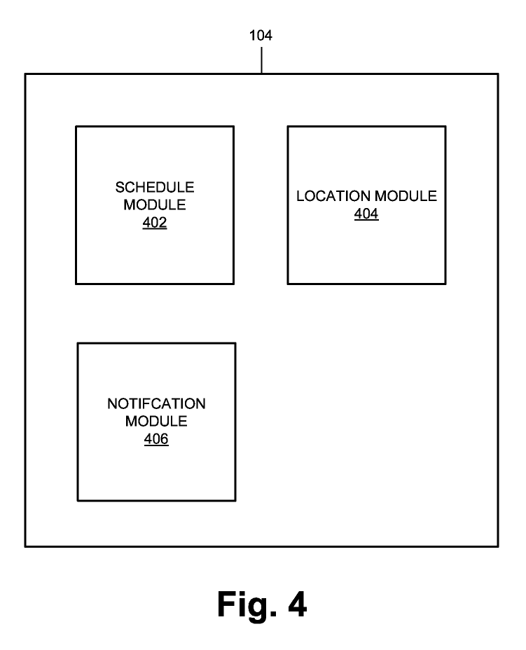

FIG. 4 is a block diagram illustrating exemplary functional components of device 104. As shown, device 104 may include a schedule module 402, location module 404, and notification module 406. For simplicity and ease of understanding, device 104 of FIG. 4 does not show other components, such as an operating system (e.g., Windows, Linux, etc.), drivers, an application (e.g., an email client, a word processor, a browser, etc.), a database, etc. Depending on the embodiment, device 104 may include additional, fewer, or different functional components than those illustrated in FIG. 4.

Schedule module 402 may receive description/information related to an event from a user and may schedule the event. In scheduling the event, schedule module 402 may store the description/information locally or send the description/information to server device 110, which may then store the description/information. The description/information may include a location and time of the event.

Location module 404 may determine the location of device 104, based on signals from, for example, location devices 102 (e.g., GPS signals). In a different embodiment, location module 404 may use, when available, scheduling information from schedule module 402 to determine the location.

Notification module 406 may notify the user of device 104 of an event, at a particular time, based on an alert from server device 110. In one embodiment, notification module 406 may notify the user via a voice message, a text message on a graphical user interface (GUI) window, etc., and may indicate the amount of time that the user may need to travel to the next event.

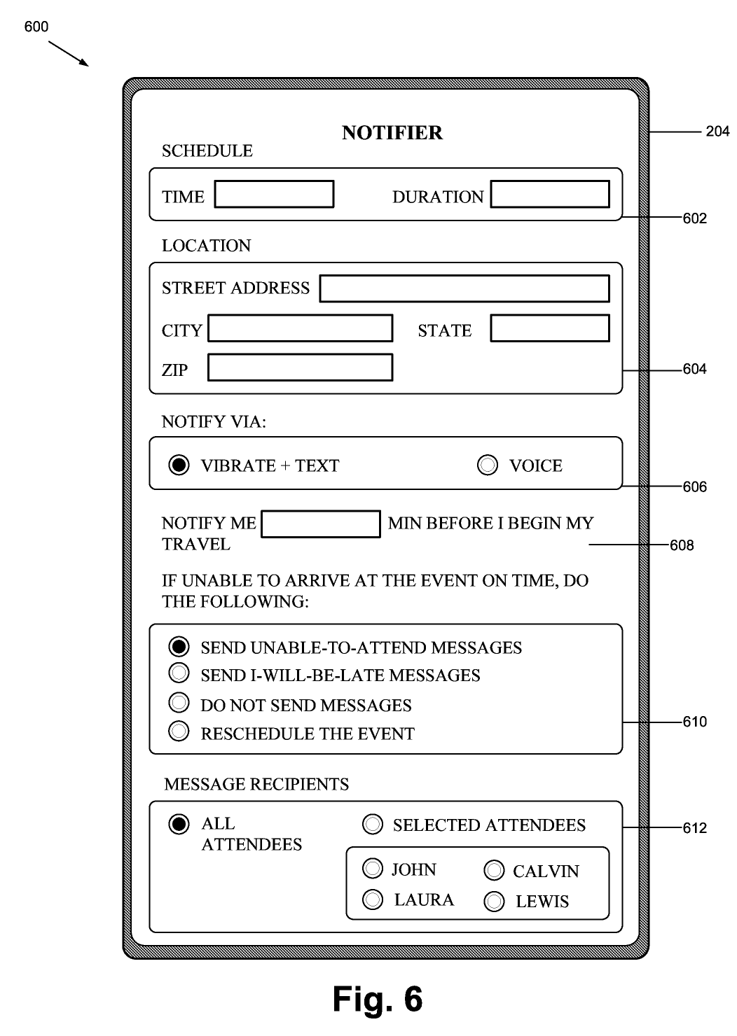

In addition, notification module 406 may allow the user to set different parameters that are associated with notifying the user, such as when the user is to be notified. For example, if the user wants to be notified 10 minutes before the user begins to travel toward the next destination, the user may input the notification time via a GUI of notification module 406. Other parameters that the user may input/set are described below in connection with FIG. 6.

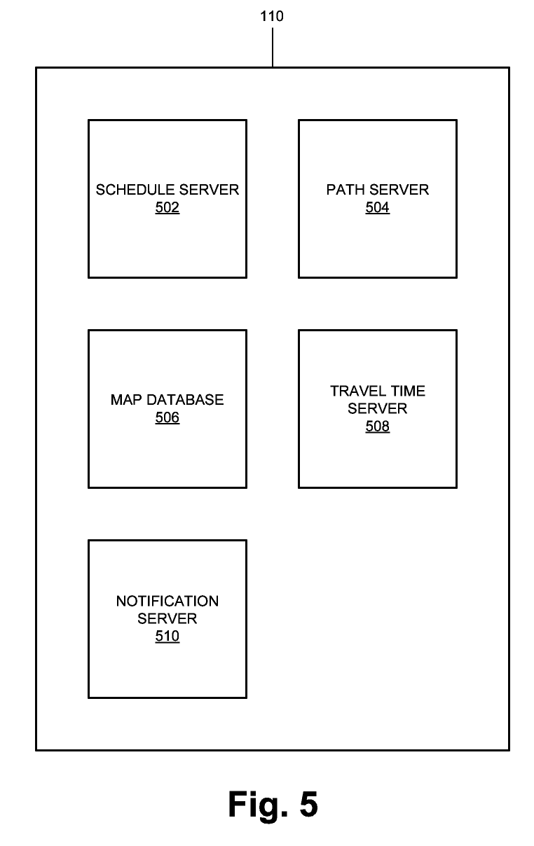

FIG. 5 is a block diagram illustrating exemplary functional components of server device 110. As shown, server device 110 may include a schedule server 502, path server 504, map database 506, travel time server 508, and notification server 510. For simplicity and ease of understanding, server device 110 of FIG. 5 does not show other components, such as an operating system, an application, etc.

Depending on the embodiment, server device 110 may include additional, fewer, or different components than the ones illustrated in FIG. 5. For example, in one embodiment, the functionalities of notification server 510 may be incorporated in device 104. In such an embodiment, server device 110 may not include notification server 510. In another example, map database 506 and/or travel time server 508 may be included in device 104 or in another, remote server device, and not in server device 110.

Schedule server 502 may receive, from schedule module 402 in device 104, description/information that describes an event, and store the description/information in a local database (not shown). In addition, in response to a request from schedule module 402, schedule server 502 may retrieve a date, a time, and/or the description/information that is associated with a particular event.

Path server 504 may receive two identifiers (e.g., names of geographical locations), each of which is associated with a geographical location, and determine physical routes between the geographical locations. Depending on the embodiment, path server 504 may use one or more criteria to limit the number of possible paths or routes that path server 504 provides to a client (e.g., the total distance being less than a certain threshold). In one embodiment, path server 504 may use map database 506 in determining the physical paths or routes. In some embodiments, the paths may depend on the mode of transportation. For example, a public bus may follow pre-specified routes. In this case, path server 504 may store or access various routes used by different modes of transportation.

Map database 506 may store and/or retrieve geographical information. The information may include coordinates of geographical features.

Travel time server 508 may provide, for each route in map database 506, an estimated amount of time that a specific mode of transportation (e.g., airplane, car, bus, bicycle, etc.) may require for traveling the route. For example, travel time server 508 may indicate that a pedestrian may take 10 minutes to walk from the intersection of 33^{rd} street and Random Boulevard to the intersection of 33^{rd} street and Broussard Street. For some public transportation types, travel time server 508 may use arrival/departure schedules associated with the specific modes of transportation to determine the travel time.

In some embodiments, travel time server 508 may use user specific information. For example, as the user travels about different geographical locations, device 104 may send location information associated with device 104 to server device 110. Based on the location information, travel time server 508 may identify routes that the user travels, and for each route, may record the amount of time the user spends on traversing the route. Such recorded times may later be used in calculating the total amount of time that the user may spend in traveling from one geographical location to another.

In other embodiments, travel time server 508 may take traffic conditions into consideration. For example, for each possible route that the user may take in traveling from one location to another, travel time server 508 may consult an information source that accounts for traffic conditions (e.g., a traffic server. Google Map, etc.) to determine the approximate travel time.

Notification server 510 may determine, at particular moments, the amount of time that a user may need to travel from one geographical location to another geographical location. In addition, notification server 510 may notify the user based on the estimated travel time, the current time, the time of the next event, and/or a heads-up time (e.g., amount of time that the user would like to be warned ahead of traveling). For example, assume that notification server 510 installed on server device 110 determines that John will need 20 minutes to drive from John's current location (e.g., an office in Maryland) to his home (e.g., a house in Washington, D.C.), the current time is 2:30 p.m., the time when John is to meet his wife at his house is 3:00 p.m., and John's heads-up time is 10 minutes. In such a case, notification server 510 may cause John's cell phone to alert John, via a voice message or a message on a display screen (e.g., “Your next scheduled event is at 3:00 p.m. Your estimated travel time is 20 minutes. You may wish to depart in 10 minutes.”).

In determining when/whether the user is to be notified, notification server 510 may use schedule server 502, path server 504, and travel time server 508. For example, in one embodiment, assume that notification server 510 periodically polls schedule server 502, and that examining the time of a scheduled event indicates that notification server 510 may need to send out a notification to the user. In such an instance, notification server 510 may obtain the current location of device 104 and the location of the next event which the user is to attend. Further, notification server 510 may query path server 504 for a list of paths that the user may take, and may consult travel time server 508 to evaluate the amount of time that the user may take to reach the next destination. Based on the amount of time that the user may take, notification server 510 may alert the user at the appropriate moment.

Depending on the embodiments and/or its configuration, notification server 510 may use one of several possible ways to evaluate the amount of time that the user may take to reach the next destination. For example, in one embodiment, by using travel time server 508, notification server 510 may compute, for each path provided by path server 504, the amount of time that the user may take to reach the destination. Notification server 510 may then select the shortest time as the travel time. In another embodiment, notification server 510 may average the travel times for different paths.

In yet another embodiment, notification server 510 may select either the longest or the shortest time of a particular number (e.g., two) of shortest routes. For example, assume that there are four possible routes to reach a destination, and that of the four routes, two routes are shorter than the others. Notification server 510 may then select the shortest time that the user may take to travel one of the two shortest paths.

In some instances, the user may select the manner in which the travel time is determined. For example, a user may wish to be early for meetings/events, and may set notification server 510 to use the longest estimated travel times for a set of routes. In contrast, another user may set notification server 510 to determine the travel time by by averaging travel times of several routes. The user may configure notification server 510 via a GUI interface.

FIG. 6 is a diagram illustrating a view of graphical user interface (GUI) 600 of notification module 406 of device 104. GUI 600 includes components for allowing the user to set different parameters that are associated with notifying the user. As shown, GUI 600 may includes a schedule pane 602, location pane 604, notification mode pane 606, heads-up time section 608, action pane 610, and message recipient pane 612. Depending on the embodiment, GUI 600 may include fewer, additional, or different components than those illustrated in FIG. 6. For example, in one embodiment, notification module 406 may obtain scheduling information from another application (e.g., a calendar application). In such embodiments, GUI 600 may not include schedule pane 602.

Schedule pane 602 may receive user input that describes the time and/or the duration of an event. In a different embodiment, schedule pane 602 may include other types of graphical components for receiving user input, such as a clock, or selectable pre-defined time-slots in a list menu, etc.

Location pane 604 may receive a description of the location (e.g., an address) at which the scheduled event is to occur. Notification mode pane 606 may allow the user to determine input/output components 308 by which the user is to be notified of the event and/or travel time. For example, in FIG. 6, the user may select “VIBRATE+TEXT” if the user wishes to be notified of the event and/or travel time by vibration of device 104, followed by a text message on, for example, display 204. Alternatively, the user may select “VOICE,” if the user wants device 104 to alert the user via a spoken text message, e.g., “Your travel time will be approximately 35 minutes. Your next meeting is at 12:40 p.m. It is now 11:15 a.m. You may wish to depart in about 50 minutes.”

Heads-up time section 608 may receive an amount of time by which the user wants to be notified prior to traveling toward the location of the event. For example, assume that the user inputs 10 minutes in a text box in heads-up time section 608. In addition, assume that the next meeting is scheduled for 2:00 p.m., and that the user will need 30 minutes to arrive at the meeting from the user's current location. The user will be notified by device 104 at 1:20 p.m., which is 10 minutes prior to 1:30 p.m., the user's estimated departure time.

Action pane 610 may allow the user to select a particular action that device 104 or server device 110 may take when the user will not be able to attend the event on time. In FIG. 6, particular actions that the user may select are illustrated as being related to sending messages (e.g., email, voice message, video clip, etc.) to some or all attendees of the event or rescheduling the event. Message recipient pane 612 may allow the user to select the recipients of the messages when the user will be late or unable to attend the event.

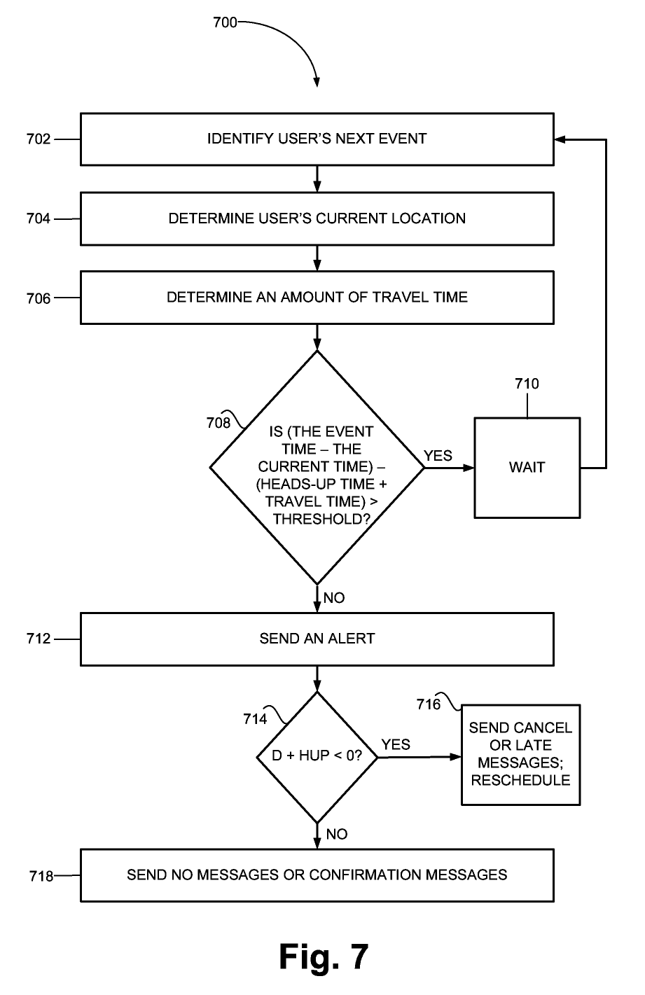

FIG. 7 is a flow diagram of an exemplary process that is associated with operation of system 100. Assume that device 104 operates in conjunction with server device 110, and that the user has input, via schedule module 402 and/or notification module 406 on device 104, his schedule for the next event and parameters that are associated with notifying the user (e.g., heads-up time, the address of the next event, etc.).

Notification server 510 may identify a next event for a user (block 702). In one embodiment, notification server 510 may identify the next event by querying schedule server 502. In the query, notification server 510 may convey search terms and/or relevant information (e.g., an identifier associated with the user, a date associated with the schedule, etc.) for schedule server 502 to lookup the schedule and return a description of the event. The description may include a location and time of the event.

Notification server 510 may determine the user's current location (block 704). In one embodiment, notification server 510 may determine the user's location by sending a request to device 104 to provide its current location. In response, device 104 may query its location module 404 to identify its location. In addition, notification server 510 may send a query to schedule server 502 to obtain a description of the current event that the user is attending. The description may include the location of the current event.

Notification server 510 may determine the amount of travel time (block 706). As described above, notification server 510 may query travel time server 508 to obtain the travel time.

Notification server 510 may determine whether a difference (D) between the time of the next event (TN) and the current time (CT) is greater than the sum of the heads-up time (HUP) and the travel time (TT) by a threshold (TH) (block 708). That is, notification server 510 may determine whether (TN−CT)−(HUP+TT)>TH. The threshold may have been pre-set during implementation of notification server 510, or alternatively, configured by a user or by a system administrator. Notification server 510 may obtain the heads-up time and the threshold from, for example, memory 304.

If the difference is greater than the threshold (block 708—YES), process 700 may proceed to block 710, where notification server 510 may wait for a period of time (block 710). The period of time for which notification server 510 waits may depend on the embodiment. For example, in one embodiment, notification server 510 may wait for a period of time that is a function of D (e.g., linear function). In another embodiment, notification server 510 may wait for a fixed period of time. After the wait, process 700 may return to block 702.

If D is less than or equal to TH (block 708—NO), process 700 may send an alert to notification module 406 on device 104 (block 712). Upon receiving the alert (e.g., a message), notification module 406 may either notify the user at once, or wait for a period of time (e.g., D) before notifying the user, so that the user will be alerted at the proper moment (e.g., HUP+TT before the event). In some embodiments, the alert may convey parameters that are determined at block 708, such as D, TN, HUP, TT, CT, etc.

At blocks 702-712, performance of notification server 510 may depend on the size of the threshold. If the threshold is large, after receiving the alert sent at block 712, device 104 may wait a significant period of time before alerting the user. In such an instance, because the original calculation of the travel time is dependent on the user's location at that time, by the time the user is notified, the travel time may no longer be accurate (e.g., the user may change locations during the wait period). If the threshold is too small, notification server 510 may iterate through blocks 702-710 a large number of times until notification server 510 sends the alert to device 104. This may result in an increased processing load on processor 302 in server device 110. Depending on the embodiment, the user, a system administrator, or some logic may select the threshold to optimize the performance of notification server 510 based on some criteria (e.g., minimize processor 302 utilization, increase the accuracy of the alert, etc.).

Notification module 406 may determine whether D+HUP is less than zero (block 714). The quantity D+HUP corresponds to the difference between the estimated travel time and the time the user actually has to travel to the next event. In one embodiment, notification module 406 may determine whether D+HUP is less than 0 (e.g., whether the user will arrive at the event on time) based on information that device 104 receives from notification server 510. In a different embodiment, notification module 406 may recalculate D based on the current time before determining whether D+HUP is less than 0 based on TN, HUP, and TT that device 104 receives from notification server 510.

If D+HUP is less than zero (e.g., the user will not arrive at the event on time), notification module 406 may send event cancellation messages and/or “I-will-be-late” messages to one or more attendees of the next event, or may reschedule the event, depending on the configuration of notification module 406 (block 716).

If D+HUP is greater than or equal to zero (e.g., the user will arrive at the event on time), notification module 406 may wait for D minutes and alert the user. Depending on its configuration and user input, notification module 406 may also send confirmation messages to the attendees of the next event (block 718).

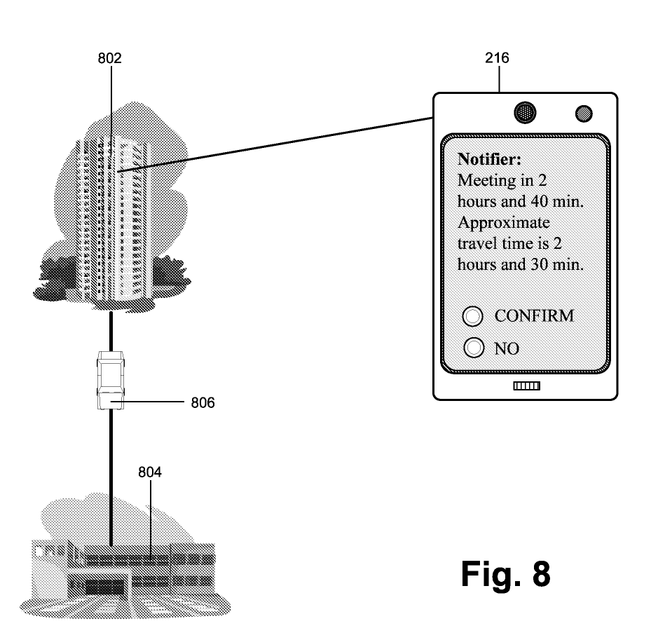

The following example, in conjunction with FIG. 8, illustrates processes that are associated with travel time notification in accordance with embodiments described above. In the example, Bob owns a device 216 that communicates with server device 110 (not shown in FIG. 8) via a wireless communication link. Assume that Bob has input heads-up time as 10 minutes, which is stored at server device 110. In addition, assume that the time is 11:00 a.m.; that Bob is currently at John's apartment 802 to install optical fibers; and that Bob is scheduled to meet his boss at his boss's office 804 at 1:30 p.m.

Bob finishes installing optical fibers at John's apartment 802, and Bob engages John in a conversation about sports. Meanwhile, server device 110, which periodically checks users' schedules, accesses Bob's schedule, and determines that Bob is to meet Bob's boss at 1:30 p.m. Consequently, server device 110 communicates with device 216 to query Bob's location. Device 216 employs location module 404 to identify its location, and returns its coordinates to server device 110. Server device 110 then determines the current time (CT), the time of the next event (TN), the travel time (TT), the heads-up time (HUP), and the quantity TN−CT−HUP−TT. The travel time is determined as 2 hours and 15 minutes.

The quantity D=TN−CT−HUP−TT is (1:30 p.m.−11:00 a.m.)−10 min−2 hrs and 15 min=5 minutes. Assume that the threshold (TH) is 7 minutes. Since D<TH, server device 110 sends an alert to device 104. Device 104 receives the alert from server device 110, and notification module 406 in device 104 determines whether D+HUP<0. Since D+HUP=5 min+10 min=15 min>0, notification module 406 may wait for D minutes and alert Bob. For example, device 104 may vibrate and display the message, “Meeting in 2 hours and 40 minutes. Approximate travel time is 2 hours and 30 minutes.” Further, device 104 may wait for Bob to input a confirmation. When Bob presses a confirmation button on device 104, device 104 may send an email message to Bob's boss, indicating that Bob is on his way.

Bob leaves John's apartment 802, gets in his car 806, and begins to drive toward his office 804.

The above example illustrates how travel time notification system 100 may operate or may be used. As discussed above, device 104 and/or server device 110 may provide a travel time dependent notification. Based on a user's current location and other factors (e.g., possible travel routes and traffic conditions), server device 110 may determine the amount of time the user may need to travel to another location (e.g., the location of the next event). Depending on the amount of time that the user may need, device 104 may notify the user, send messages to other parties (e.g., other attendees of the event), and/or cancel the next event. By accounting for the user's potential travel time, devices 104 and/or 110 may provide more useful information to the user than other types of calendar-related systems/devices.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments. For example, in different implementations, components that are described as being included in device 104 and server device 110 may be located within a single device.

Further, while series of acts have been described with respect to FIG. 7, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computer-readable medium comprising computer-executable instructions, the computer-executable instructions including instructions for:
identifying an event that is scheduled to be attended by a user;
determining a current location of a device associated with the user;
determining an estimated amount of time that the user needs to travel from the current location to the event; and
sending an alert to notify the user, the alert indicating the amount of time that is available to the user to travel to the event.

2. The computer-readable medium of claim 1, further comprising at least one of:
instructions for notifying the user, at the device, of a time of the event; or instructions for notifying the user, at the device, of the amount of time that is available to the user to travel to the event.

3. The computer-readable medium of claim 1, wherein the device includes a digital television, gaming console, media-playing device, personal computer, laptop computer, cell phone, or personal digital assistant.

4. The computer-readable medium of claim 1, wherein instructions for identifying an event includes instructions for identifying a location of the event.

5. The computer-readable medium of claim 1, wherein instructions for determining a current location of the user includes instructions for at least one of:
identifying a location of the device based on signals from satellites;
identifying a location of the device based on signals from wireless access points; or
identifying a location of the device based on scheduling information that identifies the current location.

6. The computer-readable medium of claim 1, wherein instructions for determining an estimated amount of time that the user needs to travel includes instructions for at least one of:
determining the amount of time based on traffic conditions;
determining the amount of time based on transportation type; or
determining the amount of time based on amounts of time that the user previously spent on traveling between the current location and a location of the event.

7. The computer-readable medium of claim 1, further comprising instructions for sending messages to attendees of the event.

8. The computer-readable medium of claim 7, wherein the messages indicate that the user will arrive at the event on time, the user will not arrive at the event on time, the user will not attend the event, or a new time for the event.

9. The computer-readable medium of claim 8, wherein the messages include at least one of: an email message, a voice mail, or an instant message.

10. The computer-readable medium of claim 1, further comprising instructions for determining whether the user will be able to arrive at the event on time.

11. The computer-readable medium of claim 1, further comprising instructions for receiving user input that describes a time and location of the event.

12. The computer-readable medium of claim 11, further comprising instructions for sending the received user input to a database that stores a schedule associated with the user.

13. A device comprising:
a communication interface to communicate with a remote device;
a memory for storing a time and a location of an event of a user; and
a processor to:
retrieve, from the memory, information that identifies the time and the location of the event;
receive information that identifies a location of the remote device;
determine an estimated amount of time that the user may take to travel from the location of the remote device to the location of the event; and
send a message to the remote device to alert the user of at least one of the amount of time that the user may spend to travel from the location of the remote device to the location of the next event or a departure time for traveling to the location of the event.

14. The device of claim 13, wherein the remote device is configured to determine the location of the remote device based on signals from global positioning system (GPS) devices.

15. The device of claim 13, wherein the remote device is configured to send confirmation messages to attendees of the event based on the message from the device.

16. The device of claim 13, wherein the communication interface is further configured to:
receive a schedule associated with the user from the remote device.

17. A device comprising:
a communication interface to communicate with a remote device; and
a processor to:
determine a location of the device;
send information identifying the location to the remote device;
receive a message, from the remote device, to alert a user of the device about an amount of time that the user has to travel to an event; and
generate a notification to alert the user.

18. The device of claim 17, wherein the notification includes:
a text message; a vibration; or a voice message.

19. The device of claim 17, wherein the notification includes:
information identifying an amount of time the user has to travel to the event.

20. The device of claim 17, wherein the processor is further configured to: send messages to attendees of the event that the user will be late to the event.
